(19) United States
(12) Patent Application Publication
(10) Pub. No.: US 2008/0060420 A1
(43) Pub. Date: Mar. 13, 2008

(54) Inspection dye for use in detecting cracks

(76) Inventor: Steven J. Miles, St. Charles, MO (US)

Correspondence Address: DOUGLAS E. WARREN, 109 CHESTERFIELD BUSINESS PARKWAY, CHESTERFIELD, MO, 63005, US

(21) Appl. No.: 11/981,325

(22) Filed: Oct. 31, 2007

Related U.S. Application Data
(62) Division of application No. 11/220,331, filed on Sep. 6, 2005.

(51) Int. Cl. G01M 3/04

(52) U.S. Cl. 73/40.7

(57) ABSTRACT

The present invention relates to an inspection dye for use in detecting cracks and flaws in metal surfaces to which the inspection dye has been applied.

### CROSS-REFERENCE TO RELATED APPLICATIONS

This application is a divisional application related to U.S. nonprovisional patent application Ser. No. 11/220,331 filed Sep. 6, 2005 from which all applicable priority is claimed.

### STATEMENT REGARDING FEDERALLY SPONSORED RESEARCH OR DEVELOPMENT

Not Applicable.

### BACKGROUND OF THE INVENTION

Carbon monoxide is a deadly gas that can sometimes build up within residential homes and offices as a result of faulty ventilation. If the concentration of carbon monoxide reaches sufficient levels, severe Illness and even death may occur as a result of breathing air having dangerous levels of carbon monoxide.

While there are many sources of carbon monoxide in homes and offices, the two most prevalent sources are improperly vented fuel fired water heaters and furnaces. In the case of furnaces, the carbon monoxide enters the living areas of homes as a result of fuel fired furnace heat exchangers that have developed cracks and openings over time. Fuel fired heater exchangers act to transfer heat from fuel burning around the interior of the heat exchanger while recycled air from the living area is forced around the exterior area of the heat exchanger. As the recycled air is forced around the heat exchanger, It comes near to and in contact with the exterior walls and surfaces of the heat exchanger that have bean made hot by the burning fuel.

When a heat exchanger is in proper operating condition, the exterior area of the heat exchanger has no openings that allow any of the combustion gases created by the burning of the fuel to exit to the heat exchanger exterior. Over time, however, the constant heating and cooling of the fuel fired furnace heat exchanger stresses the walls and surfaces of the heat exchanger, sometimes resulting in cracks and openings within the heat exchanger walls end surfaces. Corrosion cracks can also occur. When such cracks and openings occur, the combustion gases created by the burning fuel enter the exterior area of the heat exchanger and mix with the recycled air from the living area that is being forced around the heat exchanger. As this mixing process occurs, the concentration level of carbon monoxide, a by-product of the combustion of fuel, is raised each time the living space air is recycled through the heat exchanger. In the worst cases, the carbon monoxide level becomes high enough to cause severe injury and death to the occupant of the living area into which the recycled air is being introduced.

To prevent this situation, the heating and ventilation industry generally recommends that all fuel fired furnace heat exchangers be examined on a yearly basis to detect any cracks or openings in the heat exchanger that might allow carbon monoxide to enter the living areas. Unfortunately, the inspection process is difficult to accomplish with a high degree of confidence, because the heat exchanger is sealed and heat exchanger designs make it difficult to reach some areas. As a result, minute cracks and openings that are not generally visible to the naked human eye often go undetected.

To remedy this deficiency, some heat exchanger inspectors use an inspection dye to detect cracks and holes in the heat exchanger surfaces. The inspection dye is placed on the surface to be inspected and then the surface is placed under a detection light—usually an ultraviolet light. The fluorescent optical character of the dye causes the detection light to make surface cracks and openings show up in a more pronounced way and thus make it much easier to Identify heat exchangers that are dangerous to use.

While this inspection dye process provides a much more reliable method of inspecting fuel fired heat exchangers, there is a problem with placing the detection dye on all of the surfaces of the heat exchanger for inspection. The design of fuel fired heat exchangers includes many areas that are almost impossible to coat with inspection dye and as a result, those areas are often not inspected.

The current invention addresses this problem by providing a unique inspection dye for use in a sprayer that allows for widespread placement of the inspection dye onto surfaces that are difficult to reach, such as those within fuel fired furnace heat exchangers and water heaters.

Previously filed nonprovisional patent application Ser. No. 11/220,331 filed Sep. 6, 2005 is hereby incorporated by reference as if fully set forth herein.

### BRIEF DESCRIPTION OF THE SEVERAL VIEWS OF THE DRAWINGS

In the drawings, wherein like numerals and letters refer to like parts wherever they occur.

FIG. 1 is a front view of one embodiment of an applicator that can be used to apply one embodiment of the present invention;

FIG. 2 is a front and top view of a nozzle for the applicator that can be used to apply one embodiment of the present invention;

FIG. 3 is a view showing the location of the nozzle spray openings on the nozzle that has been shown in a flat position as if the nozzle tube had been unrolled; and

FIG. 4 is a view showing the general spray pattern obtained from the nozzle of the applicator that can be used with one embodiment of the present invention.

Corresponding reference characters indicate corresponding parts throughout the several views of the drawings.

While one embodiment of the present invention is Illustrated in the above referenced drawings and in the following description, It is understood that the embodiment shown is merely for purpose of illustration and that various changes in construction may be resorted to in the course of manufacture in order that the present invention may be utilized to the befit advantage according to circumstances which may arise, without in any way departing from the spirit and intention of the present invention, which is to be limited only in accordance with the claims contained herein.

### DETAILED DESCRIPTION

The present invention relates to an inspection dye for use in detecting cracks in metallic surfaces. One particular use of the inspection dye is to detect cracks in surfaces that are difficult to reach such as those in fuel fired furnace heat exchangers and water heaters. The following description describes how the inspection dye may be used in conjunction with a specialized sprayer having a unique nozzle capable of dispersing the inspection dye onto the surfaces to be inspected.

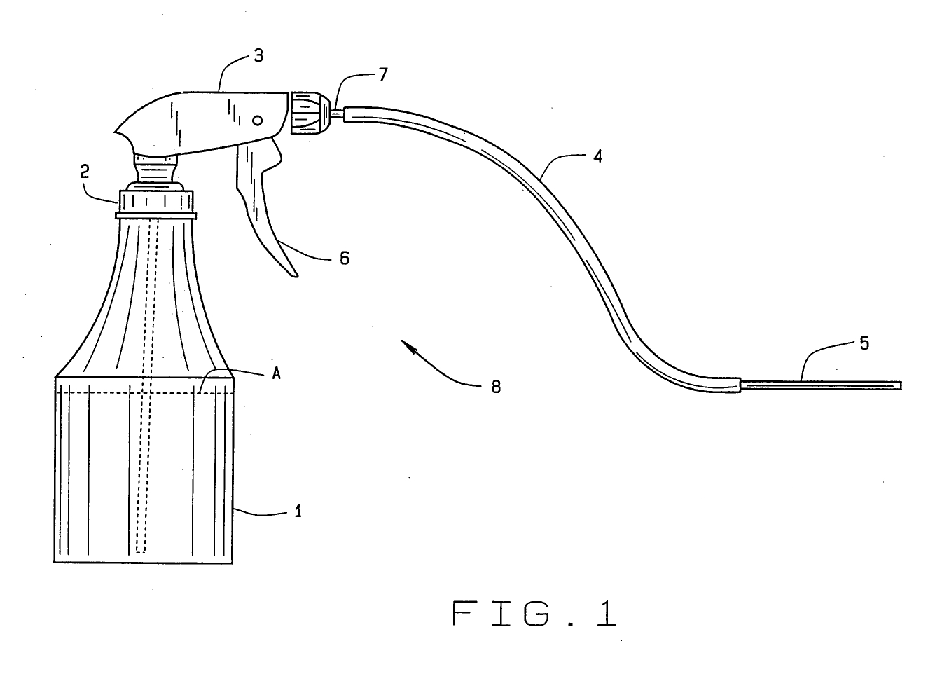

Referring now to FIG. 1, an inspection dye sprayer (hereinafter “sprayer”) 8 is shown that is used to hold and disperse an embodiment of the current invention of an inspection dye A. The sprayer 8 includes a container 1, a cap portion 2, a trigger unit 3, a transfer tube 4, and a nozzle 5. It is noted that the container 1, the cap portion 2, and the trigger unit 3 are well known in the art and can be of almost any general configuration as long as the configuration allows for the attachment of the transfer tube 4 and nozzle 5 as generally shown herein and the selected configuration provides the ability to act as a reservoir for the inspection dye A, The trigger unit 3 must also be capable of providing a pressure of about 20 pal at about 3 ml per pump when the trigger 6 is pumped by the operator to force the inspection dye from the container 1 and out of the nozzle 5.

Although the present embodiment includes the container 1, the cap portion 2, and the trigger unit 3, It is understood that other configurations for holding and distributing the inspection dye A to the nozzle 5 may also be used while remaining within the scope of the present invention. For example, the inspection dye may also be stored in a separate portable reservoir that is fluidly connected to any device that can move the inspection dye A from the reservoir and into the nozzle 5 for distribution of the inspection dye A onto the surfaces to be inspected. Also, while a manual trigger unit 3 is shown in the present embodiment, other types of transferring devices such as pneumatic pump systems, pressurized reservoirs, and electrical pumps may also be used to move the inspection dye A throughout the overall system and into the nozzle 5 for distribution.

The trigger portion 3 includes a trigger 6 and a connection port 7. The transfer tube 4 is attached to the connection port 7 of the trigger unit 3 by inserting the connection port 7 into the inside diameter of the transfer tube 4. It is understood that the dimensional relationship between the connection port 7 and the transfer tube 4 are such that when the connection port 7 is inserted within the transfer tube 4 there is a tight fit between those two components that prevents leakage of the inspection dye A as it is forced into the transfer tube 4 and out of the nozzle 5.

The transfer tube 4 is flexible and can be made from any material that will provide flexibility while not being subject to deterioration when used in conjunction with the fluorescent inspection dye described herein. The transfer tube 4 is sized to match the connection port 7 such that the outside diameter of the connection port 7 is insertable into the inside diameter of the transfer tube 4 to form a seal that prevents leakage of the inspection dye A. While the transfer tube 4 is flexible from the connection port 7 to the nozzle 5 in the present embodiment, It is understood that the length of the transfer tube 4 may be adjusted as needed for each application. For example, a rigid fluid transfer apparatus may be connected between the connection port 7 and the transfer tube 4 and the nozzle 5. That is to say, the flexible transfer tuba 4 need only occur at the nozzle 5 and be only as long as needed to allow the nozzle 5 to be inserted into the device being inspected.

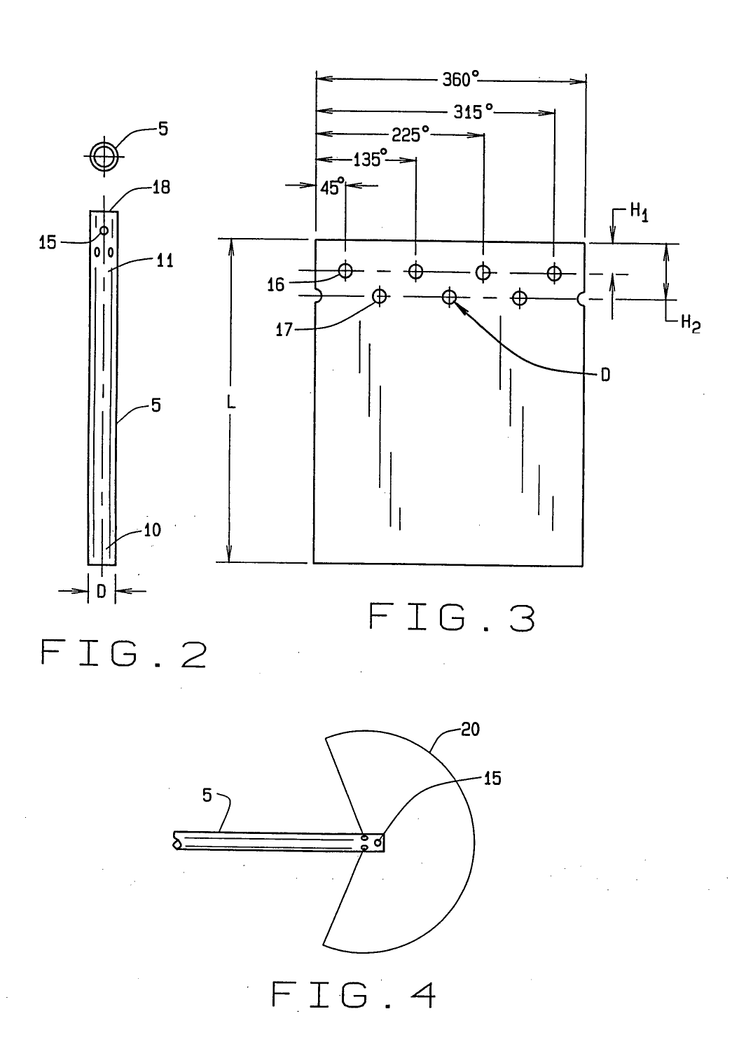

As shown in FIG. 2, the nozzle 5 in the present embodiment comprises a straight cylindrical metallic tube having an outside diameter of about 0.09 inches and 9 length “L” of about 11.00 inches. The length may be varied to fit the specific apparatus being inspected. The nozzle 5 has a proximate and 10 and a distal end 11. The proximate end 10 of the nozzle 5 is designed to allow proximate and to be inserted into the transfer tube 4 to form a seal between the proximate end 10 and the transfer tube 4, The distal end 11 of the nozzle 5 comprises a special series of spray openings 15 arranged near the tip 18 of the distal end 11.

FIG. 3 show that the spray openings 15 in the present embodiment consist of a first row of spray openings 16 and a second row of spray openings 17 that are generally located around the circumference of the distal end of the nozzle 5 in substantially equal increments of about 90 degrees. It is understood that the first row of spray openings 16 are offset circumferentially about 45 degrees from the second row of spray openings. It is also understood that the first row of spray openings 16 is located about 0.125 inches from the tip 18 of the distal end 11 of the nozzle 5, and that the second row of spray openings 17 is located about 0.219 inches from the tip 18 (FIG. 2) of the distal end 11. The tip 18 is sealed to prevent the distribution of the inspection dye from the distal end of the nozzle 5.

The spray openings 15 (FIG. 3) in each of the first row of spray openings 16 and the second row of spray openings 17 in the current embodiment are of the same size and shape. Specifically, the spray openings 17 are about 0.010 inches in diameter. In other embodiments, the spray openings 17 may be from about 0.004 to about 0.031 inches in diameter, with the diameter of the spray openings 17 being adjusted to compensate for changes in the volume capability of the trigger unit 3, the density of the inspection dye A, or the size and shape of the spray pattern 20 formed when the inspection dye is forced through the spray openings 15 as shown in FIG. 4.

In other embodiments of the present invention, the spray openings 15 are in shapes other than circles. For example, the spray openings may also be in the form of obround or rectangular silts. In yet other embodiments, the spray openings 15 may reside in more than just two rows of spray openings or may be only one row of spray openings. The actual number, size, shape and placement of the spray openings 15 may be adjusted as needed to fit a particular operational need while still being within the scope of the present invention as long as the combination used provides for the application of the inspection dye A onto the difficult to reach surfaces of items such as gas furnace heat exchangers.

The inspection dye A is a unique composition of material that allows the inspection dye A to be used with the sprayer 8 and nozzle 5 as described above. More specifically, the inspection dye A is a non-toxic, non-corrosive, smoke-less, low-odor, dye penetrant. It is generally a solution of alcohol and water mixed with a fluorescing material. In the present embodiment of the inspection dye A, the inspection dye comprises water, a solvent, and a fluorescent material.

The solvent may be any type of aliphatic alcohol hydrocarbon, however, the solvent used in one preferred embodiment of the present invention is isopropyl alcohol.

The fluorescent material may be any material or combination of materials that can be activated by ultraviolet light and that emits in the visible light spectrum when Irradiated by an ultraviolet light source having a wavelength of between about 365 nm and about 380 nm. The fluorescent material is preferably soluble in the solvent, but may also be utilized as a mixture with the fluorescent material suspended therein. One example of an acceptable fluorescent material that may be used with the present invention is a product named UVHG, that is manufactured by a Carlstadt, New Jersey named MAXMAX. The fluorescent materials are preferably solids in the dry state so that as the solvent evaporates, the fluorescent material will precipitate out of solution and deposit within the cracks and flaws of the surface upon which the inspection dye A has been applied, It is understood that the fluorescent material may be mixed with one or more different fluorescent materials and the inspection dye may contain a combination of fluorescent materials. Such fluorescent materials are well known in the art as are methods for their preparation.

In one embodiment of the present invention, the inspection dye A uses isopropyl alcohol as the solvent, where the inspection dye A contains, by weight, about 20% isopropyl alcohol, between about 79.993% and about 79.970% water, and between about 0.007% and about 0.030% of fluorescent material: that is, about 0.25 grams and about 1.0 gram of fluorescent material per gallon of inspection dye A.

When the inspection dye A is used, signs of any cracks on the metallic surfaces to be inspected show are made visible when the surface to be inspected is displayed under ultraviolet light. For example, one embodiment of the present invention, the inspection dye A is used to detect cracks in the heat exchanger of a gas-fired furnace. In that embodiment, the inspection dye A is injected into the furnace cabinet and onto the heat exchanger cells through holes as small as 0.125 inch diameter that usually occur in the furnace cabinets and front panels of most furnaces, with the insertion limit hole being the most obvious. The sprayer 8 is used to completely saturate the “air-side” of the heat exchanger by first inserting the nozzle 5 into each hole between the heat exchanger cells and aiming the nozzle 5 at an upward angle and moving the nozzle from side to side while spraying the inspection dye A to generally saturate each cell of the heat exchanger from front to back, and top to bottom, and to generally saturate the first few inches of the heat exchanger near the opening into which the nozzle 5 is placed. It is understood that while the inspection dye A in this embodiment is used in conjunction with the sprayer 8 and the nozzle 5, the inspection dye A may also be used and applied with any other sprayer or device capable of depositing the inspection dye A onto any surface to be inspected and still remain within the scope of the present invention.

Once the inspection dye A has been placed upon all of the surfaces to be inspected, those surfaces are inspected for cracks on the “combustion-side” of each cell of the heat exchanger by illuminating the surfaces covered with the inspection dye A with ultraviolet from a source such as a flashlight. A mirror may be used in conjunction with the flashlight to assist in viewing surfaces that are more difficult to inspect. Any cracked surface upon which the inspection dye A has been placed will display the cracks as concentrated areas of the fluorescent material from the inspection dye A and will appear as either straight or irregular lines of fluorescing material, or may appear as a puddle of fluorescent material in the heat exchanger crack if the crack itself is not visible. Such puddles also indicate a breech of the heat exchanger material. The detection of such cracks is an indicator to the technician that the heat exchanger is defective and will likely need replacement.

While the above description describes various embodiments of the present invention, it will be clear that the present invention may be otherwise easily adapted to fit any configuration where an inspection dye is required. Additionally, as various changes could be made in the above constructions without departing from the scope of the invention, it is also intended that all matter contained in the above description or shown in the accompanying drawings shall be interpreted as illustrative and not in a limiting sense. The scope of the invention should be determined by the appended claims and their legal equivalents, rather than by the examples given.

What is claimed is:

1. A process for detecting cracks and flaws in the surface of an object which comprises the steps of:
applying an inspection dye to a surface, wherein the inspection dye is a composition comprising, by weight, about 20% isopropyl alcohol, between about 79.993% and about 79.970% water, and between 15 about 0.007% and about 0.030% fluorescent material, irradiating the surface with an ultraviolet light to activate the fluorescent material such that the fluorescent material emits radiation in the visible light spectrum; and
detecting one of either cracks or flaws in the surface by observing a residue of the fluorescent material that signals the general locations of a crack or flaw.

2. A process of marking objects for subsequent inspection thereof that comprises contacting an object with the inspection dye of claim 1.
